(19) United States
(12) Patent Application Publication
(10) Pub. No.: US 2004/0073925 A1
(43) Pub. Date: Apr. 15, 2004

(54) Content delivery server with format conversion function

(75) Inventor: Haruhiko Kinoshita, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/671,790

(22) Filed: Sep. 29, 2003

(30) Foreign Application Priority Data
Sep. 27, 2002 (JP) 2002-282702

(51) Int. Cl. G06F 13/00; H04N 5/445; G06F 3/00; H04N 7/025; H04N 7/10

(52) U.S. Cl. 725/46; 725/34; 725/35

(57) ABSTRACT

A server stores user information indicative of content replaying environment and a plurality of format conversion programs. When receiving a content delivery request including a content from a content owner, the server searches for a most suitable format conversion program to convert the content to a format suitable for the user environment. The format-converted content is delivered to the user. The optimum content format is automatically provided to the content user without burdening the content owner and the content user.

### BACKGROUND OF THE INVENTION

1. Field of the Invention

The present invention relates to a network-based electronic data delivery system, and in particular to a technique of delivering contents for movies, television programs and the likes to users through a communication network.

2. Description of the Related Art

In recent years, attention is being given to an electronic movie-content delivery system, which delivers the movie content to film-distributing firms, movie theaters or home theaters through a communication network. There have been disclosed movie data delivery systems or electronic cinema systems in, for example, Japanese Patent Application Unexamined Publication Nos. 2002-118834 and 2002-171471.

However, an environment where movie is screened varies from one theater to another. For example, different theaters may employ different projectors, different sound systems, and different screen reflection factors, or may have different acoustics and reverberation times. Accordingly, in order to screen the movie in best condition, it is necessary to convert the format of movie content to meet the environmental conditions of the theater. Further, movie content is not only delivered to theaters but also stored into DVDs or videotapes to be sold or broadcast in television. In these cases, the format of movie content should be also converted to meet the media to be used.

As describe above, to screen the movie in best condition, content providers or users are burdened with such format conversion, which needs significantly complicated and cumbersome operations.

### SUMMARY OF THE INVENTION

An object of the present invention is to provide a content delivery server and content delivery method, allowing easy operations to meet various usage environments of content users.

According to the present invention, a server for delivering a content to a plurality of users through a network, includes: a first memory for storing user information corresponding to each of the users, the user information indicating at least content replaying environment of the user; a second memory for storing a plurality of format conversion programs each corresponding to a plurality of predetermined content replaying environments; a format conversion selector for selecting a most suitable one from the format conversion programs based on the content replaying environment of the user, wherein the most suitable format conversion program provides a format most suitable for the content replaying environment of the user; a format converter for converting the content into the format according to the most suitable format conversion program to produce a format-converted content for the user; and a transmitter for transmitting the format-converted content to the user through the network.

The content replaying environment of the user may include a type of replaying equipment of the user.

The content may be included in a content delivery request received from a content owner, wherein the content delivery request further includes delivery destination identifying each of the users. The server may further include a content storage section for storing the content received from the content owner.

As an embodiment of the present invention, the content is a movie content, wherein the content replaying environment of the user includes screen information, projector information, and sound information, which identifies an environment of a movie theater of the user.

As another aspect of the present invention, a server for delivering a content to a plurality of users through a network, includes: a first memory for storing user information corresponding to each of the users, the user information indicating at least content replaying environment of the user; a second memory for storing a plurality of format conversion programs each corresponding to a plurality of predetermined content replaying environments; a third memory for storing correspondences between the users and the plurality of format conversion programs, wherein each of the correspondences is determined by selecting a most suitable one from the format conversion programs based on the content replaying environment of each of the users; a format converter for converting the content into the format according to a format conversion program which is determined by searching the third memory for a corresponding user, to produce a format-converted content for the user; and a transmitter for transmitting the format-converted content to the user through the network.

According to the present invention, a method for delivering a content to a plurality of users through a network, includes the steps of: preparing a first memory storing user information corresponding to each of the users, the user information indicating at least content replaying environment of the user; preparing a second memory storing a plurality of format conversion programs each corresponding to a plurality of predetermined content replaying environments; when a content delivery request identifying a user and a content is received from a content owner, searching the first memory for the user to find corresponding user information; selecting a most suitable one from the format conversion programs based on the content replaying environment included in the found user information, wherein the most suitable format conversion program provides a format most suitable for the content replaying environment of the user; converting the content into the format according to the most suitable format conversion program to produce a format-converted content for the user; and delivering the format-converted content to the user through the network.

As described above, the server converts the content to be delivered from the content owner to the content user into the format suitable for the user environment. Therefore, the optimum content format is automatically provided to the content user without burdening the content owner and the content user. In other words, the content owner can provide its own content to a plurality of content users without the need of converting the content to different formats each meeting the user environments or preparing a plurality of contents each having the different formats. By just registering user information into only the content providing server 10, the content user can obtain various content delivery services with most suitable format for the user's environment. There is no need of registering its own user information into each of the content owners.

### BRIEF DESCRIPTION OF THE DRAWINGS

FIG. 1 is a block diagram showing a content delivery system employing a content delivery server according to an embodiment of the present invention;

FIG. 2 is a flowchart showing a user registration procedure of the content delivery server;

FIG. 3A is a diagram showing an example of a user information entry screen displayed on a user terminal;

FIG. 3B is a diagram showing the contents of a management database used in the content delivery server according to the embodiment;

FIG. 4 is a flowchart showing a format conversion program setting procedure of the content delivery server;

FIG. 5 is a diagram showing a result of the format conversion program setting procedure; and

FIG. 6 is a flowchart showing a content providing process of the content delivery server.

### DESCRIPTION OF THE PREFERRED EMBODIMENT

### Content Delivery System

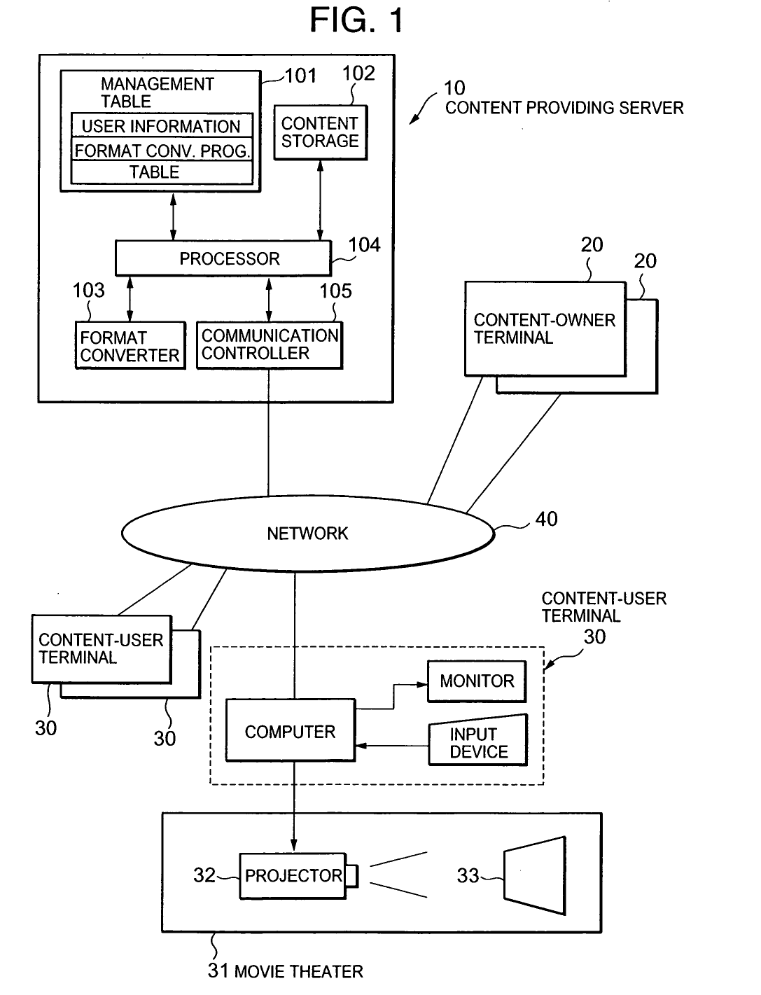

Referring to FIG. 1, a content delivery system includes a content providing server 10, a plurality of content-owner terminals 20, and a plurality of content-user terminals 30, which are capable of communicating with each other through a communication network 40 such as the Internet. In this disclosure, the term “content” means electronic data of various kinds of content such as movie, television program, recorded event program, moving-picture or still-image data, and text-based or graphical information. In this embodiment, it is assumed that movie content is delivered to a content-user terminal 30, which may be provided in a movie theater. The term “movie content” means electronic data of a film movie, video data captured by a digital video camera, moving-picture data created by animation or computer-graphics software, and the like.

The content providing server 10 is typically a Web server. The content providing server 10 is provided with a management database 101, a content storage device 102, a format converter 103, and a communication controller 105, which are controlled by a program-controlled processor 104.

The management database 101 stores user information of user's usage environments, format conversion programs for different usage conditions, and a correspondence table, which will be described later. The content storage device 102 may be a hard disk drive for storing content data (here, movie data) to be delivered. The content storage device 102 can be eliminated as described later. The content data is received from the content-owner terminal 20 through the network 40. The format converter 103 uses a selected format conversion program from the management database 101 to convert the requested content data into a format suitable for the user's usage environment. As described later, the selected format conversion program is determined depending on user information registered in the management database 101. Under the control of the processor 104, the communication controller 105 allows content delivery to the content-user terminal 30 through the network 40.

The processor 104 runs a control program to perform user information registration, format conversion, and content providing operation, which will be described later. The content providing control program is stored in a ROM (not shown) in the content providing server 10.

The content-owner terminal 20 may be a personal computer, which is managed by a content owner such as a movie producer or the like. The content-user terminal 30 may be a personal computer equipped with a monitor and an input device such as a keyboard and a pointing device. Here, a content user is a movie theater manager or a television broadcasting station.

The content-user terminal 30 is capable of communicating with the content providing server 10 through the network 40 and controlling a projector 32 installed in a movie theater 31. The computer of the content-user terminal 30 receives movie data from the content providing server 10 through the network 40 and instructs the projector 32 to project the movie on a screen 33.

### User Information Registration

A content user who has already been registered in the content delivery system uses the content-user terminal 30 to accesses the content providing server 10 through the network 40. The content providing server 10 performs validation and authentication of the visitor by checking user ID and password entered by the content user operating the input device of the content-user terminal 30. After having been successfully authenticated, the content user is permitted to request user information registration or update.

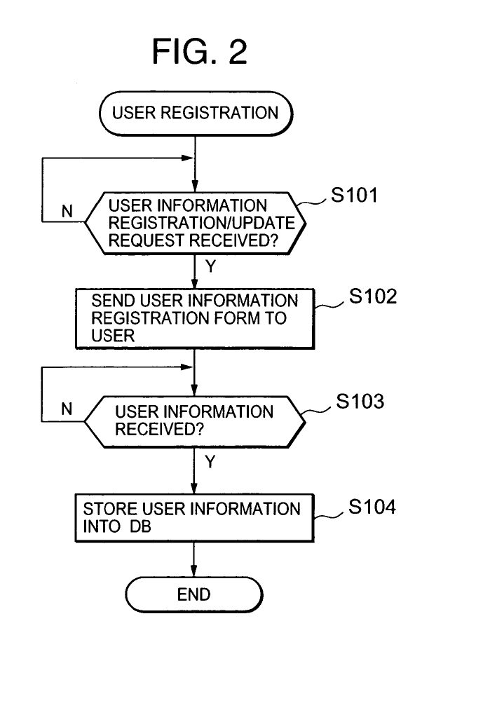

Referring to FIG. 2, when having received a request for user information registration or update (YES in step S101), the content providing sever 10 sends a user registration form back to the content-user terminal 30 (step S102) and waits for a response (step S103). In the case of the content user having already registered user information, the user registration form filled with registered information is sent to the content-user terminal 30.

At the content-user terminal 30, the user registration form is displayed on the monitor. The content user uses the keyboard to enter or update necessary information such as the type and usage of the projector 32 used in the movie theater 31 into the user registration form and sends it back to the content providing server 10. When having received the response from the content-user terminal 30 (YES in step S103), the content providing server 10 registers the received user information into the management database 101 or updates the registered user information (step S104).

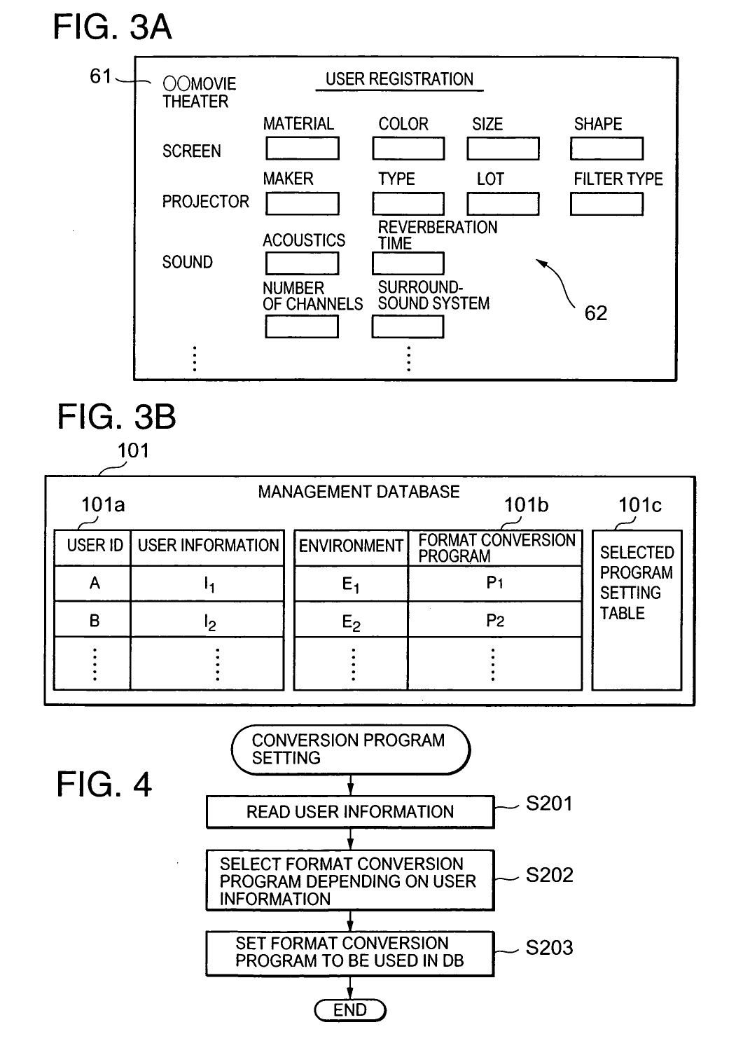

As shown in FIG. 3A, the user registration form contains the name of movie theater 61 and the user information 62. The user information 62 includes information of equipment of the movie theater 31 and the usage environment thereof. For example, the user information 62 includes:

Screen information including material, color, size, and shape,

Projector information including maker, type, lot, and filter type, and

Sound information including acoustics, reverberation time, the number of channels, and surround system.

As described before, the user information 62 is necessary to determine the most suitable format of movie content for the movie theater 31. The user information 62 may include input items for adjusting color characteristics such as white or brightness.

The projector and sound information are used to identify the file format of movie content suitable for the movie theater 31. The screen information is used to identify an optimum brightness and sound quality. In the case where a relatively poor sound system is installed in a movie theater, it may be preferable to select a format allowing a small amount of movie data with not high audio quality. Accordingly, by adjusting the above items regarding the file format, brightness and sound quality, the optimum condition can be obtained for the movie-screening environment.

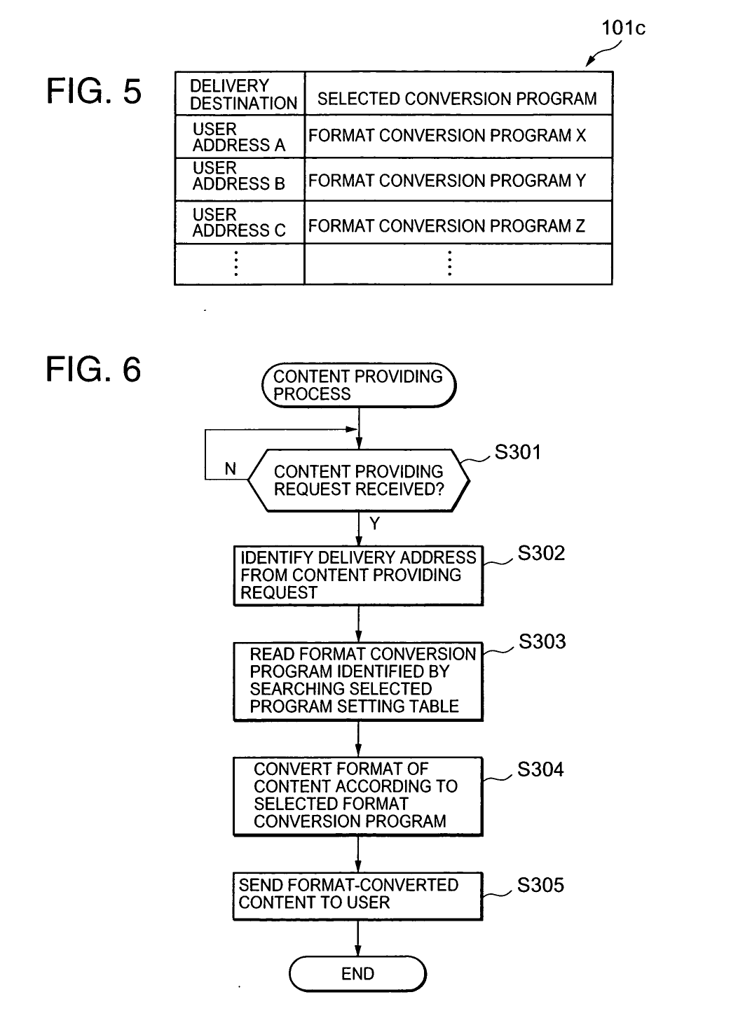

As shown in FIG. 3B, the management database 101 contains a first memory for storing user information 101a as described above for each user ID, a second memory for storing format conversion information 101b containing a plurality of format conversion programs P1, P2, . . . , and a third memory for storing a selected program setting table 101c. The format conversion programs P1, P2, . . . are each prepared for different equipment environments E1, E2, . . . , each of which can be identified depending on the projector information, the sound information and, if necessary, screen information. The selected program setting table 101c will be shown in FIG. 5.

### Format Conversion Program Setting

When user information has been registered (or updated), the format conversion program setting process is performed based on the registered user information to select an optimum one of the format conversion programs stored in the management database 101.

Referring to FIG. 4, when the user information of a content user has been registered, the processor 104 of the content providing server 10 reads the registered user information from the management database 101 (step S201). Based on the projector information and the sound information of the user information, the processor 104 identifies an equipment environment of the content user to select a corresponding format conversion program (step S202). The selected format conversion program is stored with corresponding to the user ID in the selected program setting table 101c of the management database 101 (step S203). More specifically, the selected program setting table 101c is updated so as to associate the selected format conversion program with the content user. In this manner, optimum format conversion programs each corresponding to content users are selected and stored in the selected program setting table 101c of the management database 101 as shown in FIG. 5.

In FIG. 5, the selected program setting table 101c contains correspondences between format conversion programs and delivery destinations (content users). For example, the address of a content user A is associated with a format conversion program X. Therefore, when a user ID is given, a format conversion program most suitable for equipment environment of that user can be identified.

### Content Providing

Hereinafter, a content providing operation of the content providing server will be described with reference to FIG. 6.

First, an authorized content user operates the content-user terminal 30 to send a request for delivery of a certain movie to the content-owner terminal 20. When the delivery request has been received from the content-user terminal 30 of the authorized content user, the content-owner terminal 20 sends a content providing request to the content providing server 10. The content providing request contains the following information: the user ID and address of an authorized content user; and a movie content C, which the content user wishes to see. The movie content C is stored in the content storage device 102.

Referring to FIG. 6, when the content providing server 10 has received the content providing request from the content-owner terminal 20 through the network 40 (YES in step S301), the processor 104 identifies the delivery destination address of the movie content C by looking at the content providing request (step S302). The processor 104 uses the identified delivery address to search the selected program setting table 101c of the management database 101 to identify a corresponding format conversion program and load it from the management table 101 to the format converter 103 (step S303).

Under the control of the processor 104, the format converter 103 reads the movie content C from the content storage device 102 and executes the selected format conversion program to convert the movie content C into the format most suitable for the environment of the content user (step S304). The format-converted movie content C is sent to the content-user terminal 30 through the network 40 (step S305). When the content is transferred through the network 40, data compression and encryption are preferably employed so as to burden the network 40 with fewer loads and prevent data leakage.

Since the format-converted movie content C received from the content providing server 10 is most suitable for the movie theater 31, the movie screened in the movie theater 31 can provide the optimum quality of sound and picture.

As described above, the content to be delivered from the content-owner terminal 20 to the content-user terminal 30 is converted to the format suitable for the user environment by the content providing server 10. Therefore, the optimum content format is automatically provided to the user without burdening the content owner and the content user. In other words, the content owner can provide its own content to a plurality of content users without the need of converting the content to different formats each meeting the user environments or preparing a plurality of contents each having the different formats. By just registering user information into only the content providing server 10, the content user can obtain various content delivery services with most suitable format for the user's environment. There is no need of registering its own user information into each of the content owners.

In this embodiment, the content is stored in the content storage device 102 of the content providing server 10. Therefore, the content can be stored in the content providing server 10 before delivery. By the user directly requesting the content providing server 10, the content providing server 10 can provide the format-converted content to the user in response to the content delivery request. In this case, the content owner does not need to hold the content or carry the content data on the content providing request to be sent to the content providing server 10.

As another example of the present embodiment, the content data included in the content providing request can be converted in format and then sent to the user without storage in the content providing server 10. In this case, the content storage device 102 can be removed from the content providing server 10.

The content user is not limited to a movie theater manager or television broadcast station. An ordinary personal user may use the content delivery system. In the case of personal users, a personal computer or a mobile telephone and the display thereof may correspond to the content-user terminal 30, the projector 32 and the screen 33. Therefore, the type of a personal computer or a mobile telephone may be used as its user information.

In the case of a plurality of content owners each having different contents, the different contents preferably have the same format, which allows a simple operation of the content providing server 10. If the different contents have different formats, it is preferable that contents provided by each owner have the same format. In this case, it is necessary to provide the content providing server 10 with a function of identifying the format of contents received from each owner.

In the above-described embodiment, the format-converted content may be delivered as a single unit from the content providing server 10 to the content-user terminal 30 through the network 40. In this case, the format-converted content is stored in the content-user terminal 30 and may be screened repeatedly in the movie theater 31. Alternatively, a well-known streaming technology may be used to send the format-converted content to the content-user terminal 30 through the network 40. In this case, the content-user terminal 30 controls the projector 32 to replay the received content while receiving the content from the content providing server 10.

Any billing system may be employed. For example, the content providing server 10 bills the content user for the content delivery service and instructs a banking institution to transfer a use charge from an account of the content user to an account of the content owner.

The user information or content data may be written into a recording medium such as DVD and the recording medium may be sent by mail. It is possible to make paper-based transfer of user information.

1. A server for delivering a content to a plurality of users through a network, comprising:
a first memory for storing user information corresponding to each of the users, the user information indicating at least content replaying environment of the user;
a second memory for storing a plurality of format conversion programs each corresponding to a plurality of predetermined content replaying environments;
a format conversion selector for selecting a most suitable one from the format conversion programs based on the content replaying environment of the user, wherein the most suitable format conversion program provides a format most suitable for the content replaying environment of the user;
a format converter for converting the content into the format according to the most suitable format conversion program to produce a format-converted content for the user; and
a transmitter for transmitting the format-converted content to the user through the network.

2. The server according to claim 1, wherein the content replaying environment of the user includes a type of replaying equipment of the user.

3. The server according to claim 1, wherein the content is included in a content delivery request received from a content owner, wherein the content delivery request further includes delivery destination identifying each of the users.

4. The server according to claim 3, further comprising a content storage section for storing the content received from the content owner.

5. The server according to claim 1, wherein the content is a movie content, wherein the content replaying environment of the user includes screen information, projector information, and sound information, which identifies an environment of a movie theater of the user.

6. A server for delivering a content to a plurality of users through a network, comprising:
a first memory for storing user information corresponding to each of the users, the user information indicating at least content replaying environment of the user;
a second memory for storing a plurality of format conversion programs each corresponding to a plurality of predetermined content replaying environments;
a third memory for storing correspondences between the users and the plurality of format conversion programs, wherein each of the correspondences is determined by selecting a most suitable one from the format conversion programs based on the content replaying environment of each of the users;
a format converter for converting the content into the format according to a format conversion program which is determined by searching the third memory for a corresponding user, to produce a format-converted content for the user; and
a transmitter for transmitting the format-converted content to the user through the network.

7. A method for delivering a content to a plurality of users through a network, comprising the steps of:
preparing a first memory storing user information corresponding to each of the users, the user information indicating at least content replaying environment of the user;
preparing a second memory storing a plurality of format conversion programs each corresponding to a plurality of predetermined content replaying environments;
when a content delivery request identifying a user and a content is received from a content owner, searching the first memory for the user to find corresponding user information;
selecting a most suitable one from the format conversion programs based on the content replaying environment included in the found user information, wherein the most suitable format conversion program provides a format most suitable for the content replaying environment of the user;
converting the content into the format according to the most suitable format conversion program to produce a format-converted content for the user; and
delivering the format-converted content to the user through the network.

8. A system for delivering a content from a content owner to a plurality of users through a network, comprising:
a content providing server which receives the content from the content owner to send it to each of the users,
wherein the content providing server comprises:
a first memory for storing user information corresponding to each of the users, the user information indicating at least content replaying environment of the user;
a second memory for storing a plurality of format conversion programs each corresponding to a plurality of predetermined content replaying environments;
a format conversion selector for selecting a most suitable one from the format conversion programs based on the content replaying environment of the user, wherein the most suitable format conversion program provides a format most suitable for the content replaying environment of the user;
a format converter for converting the content into the format according to the most suitable format conversion program to produce a format-converted content for the user; and
a transmitter for transmitting the format-converted content to the user through the network.

9. A program instructing a computer to deliver a content to a plurality of users through a network, comprising the steps of:
preparing a first memory storing user information corresponding to each of the users, the user information indicating at least content replaying environment of the user;
preparing a second memory storing a plurality of format conversion programs each corresponding to a plurality of predetermined content replaying environments;
when a content delivery request identifying a user and a content is received from a content owner, searching the first memory for the user to find corresponding user information;
selecting a most suitable one from the format conversion programs based on the content replaying environment included in the found user information, wherein the most suitable format conversion program provides a format most suitable for the content replaying environment of the user;
converting the content into the format according to the most suitable format conversion program to produce a format-converted content for the user; and
delivering the format-converted content to the user through the network.
